(19) United States
(12) Patent Application Publication
(10) Pub. No.: US 2014/0054405 A1
(43) Pub. Date: Feb. 27, 2014

(54) SEAT BELT WEB RETRACTORS AND ASSOCIATED SYSTEMS AND METHODS

(71) Applicants: John Clark, Granger, IN (US); Robert Desmarais, Washington Twp, MI (US); Graham Betteridge, Staines (GB); Ken Kohlndorfer, Roseville, MI (US); Martin Phillips, West Sussex (GB); Andy Toth, Goshen, IN (US); Bruce Flora, Elkhart, IN (US); Brandon Marriott, Goshen, IN (US); Michael Alan Wiseman, Zionsville, IN (US); Ruth Hamilton, Goshen, IN (US)

(72) Inventors: John Clark, Granger, IN (US); Robert Desmarais, Washington Twp, MI (US); Graham Betteridge, Staines (GB); Ken Kohlndorfer, Roseville, MI (US); Martin Phillips, West Sussex (GB); Andy Toth, Goshen, IN (US); Bruce Flora, Elkhart, IN (US); Brandon Marriott, Goshen, IN (US); Michael Alan Wiseman, Zionsville, IN (US); Ruth Hamilton, Goshen, IN (US)

(73) Assignee: AmSafe Commercial Products, Inc., Elkhart, IN (US)

(21) Appl. No.: 13/566,990

(22) Filed: Aug. 3, 2012

Related U.S. Application Data
(60) Provisional application No. 61/514,743, filed on Aug. 3, 2011.

(51) Int. Cl. B60R 22/405

(52) U.S. Cl. CPC B60R 22/405
USPC 242/383.2; 242/384; 29/428

(57) ABSTRACT

Seat belt web retractors and associated systems and methods are described herein. Web retractors assemblies configured in accordance with various embodiments of the present technology can include, for example, a frame having a first sidewall and a second sidewall opposite the first sidewall, and a spring-loaded shaft extending between the first and second sidewalls. The web retractor can further include a locking mechanism positioned proximate to the first sidewall of the frame and operably coupled to the shaft. The locking mechanism can include a vehicle inertia sensor and/or a web inertia sensor. A cover can enclose the locking mechanism such that the cover and the first sidewall form a liquid-sealed enclosure around the locking mechanism.

### CROSS-REFERENCE TO RELATED APPLICATIONS

This application claims priority to U.S. Provisional Application No. 61/514,743, filed Aug. 3, 2011, entitled “SEAT BELT WEB RETRACTORS AND ASSOCIATED SYSTEMS AND METHODS”, which is incorporated herein by reference in its entirety.

### TECHNICAL FIELD

The following disclosure relates generally to seat belt web retractors and associated systems and methods.

### BACKGROUND

Seat belt systems are used to restrain passengers in automobiles, aircraft, recreational utility vehicles (RUVs), and other vehicles in the event of a crash or other potentially dangerous event. In automobiles, seat belt systems typically include a belt or web that can be pulled from a web retractor fixedly attached to a mounting structure on one side of a vehicle seat. The web can be extended across the occupant's body, and the free end of the web, which typically carries a connector tongue, can be releasably engaged with a buckle anchored to the base of the seat or the floor opposite the web retractor. Conventional web retractors typically include a spring-loaded spool that maintains tension on the web and retracts the web when it is not in use.

### BRIEF DESCRIPTION OF THE DRAWINGS

FIG. 1A is a side view of an occupant seated in a vehicle having a restraint system with a web retractor configured in accordance with an embodiment of the present technology.

FIG. 1B is an isometric view of a restraint system with a web retractor configured in accordance with another embodiment of the present technology.

FIGS. 2A and 2B are isometric views of a web retractor configured in accordance with an embodiment of the present technology.

FIG. 3A is a side view of the web retractor of FIGS. 2A and 2B illustrating a spring assembly configured in accordance with an embodiment of the present technology, and

FIG. 3B is an enlarged view of a portion of the spring assembly of FIG. 3A.

FIG. 4A is a partially exploded isometric view of the web retractor of FIGS. 2A and 2B.

FIGS. 4B and 4C are side views of the web retractor of FIG. 4A illustrating a locking mechanism configured in accordance with an embodiment of the present technology.

FIGS. 4D and 4E are side and isometric views, respectively, of an underlying portion of the locking mechanism of FIGS. 4B and 4C, configured in accordance with an embodiment of the present technology.

FIG. 5 is a side cross-sectional view of a portion of a web retractor configured in accordance with another embodiment of the present technology.

FIGS. 6A and 6B are isometric and exploded isometric views, respectively, of a web retractor configured in accordance with a further embodiment of the present technology.

FIG. 6C is an isometric side view of the web retractor of FIGS. 6A and 6B illustrating sealing features for a locking mechanism configured in accordance with an embodiment of the present technology.

FIGS. 6D and 6E are enlarged isometric and exploded isometric views, respectively, of a sealed bearing configured in accordance with an embodiment of the present technology.

### DETAILED DESCRIPTION

The present disclosure describes seat belt web retractors and associated systems and methods. A web retractor configured in accordance with an embodiment of the present technology can include, for example, a spring engagement feature to facilitate installation of a drive spring, a conical bearing feature to reduce friction on a rotating shaft, a locking mechanism triggered by a web inertia sensor and/or a vehicle inertia sensor, and a load limiting feature to prevent undue seat belt pressure on a vehicle occupant. Additionally, web retractors configured in accordance with embodiments of the present technology can include features that inhibit debris (e.g., dirt) and/or liquids (e.g., water) from entering and interfering with the mechanisms of the web retractor.

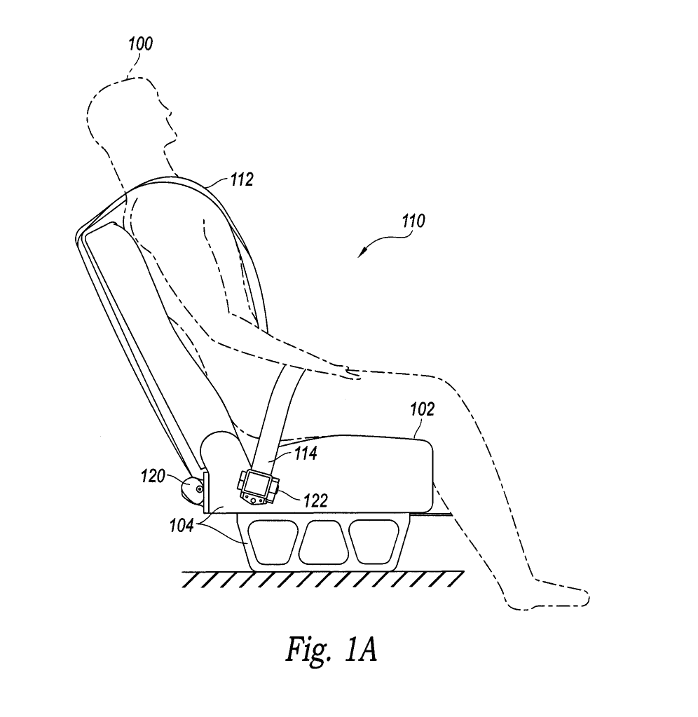

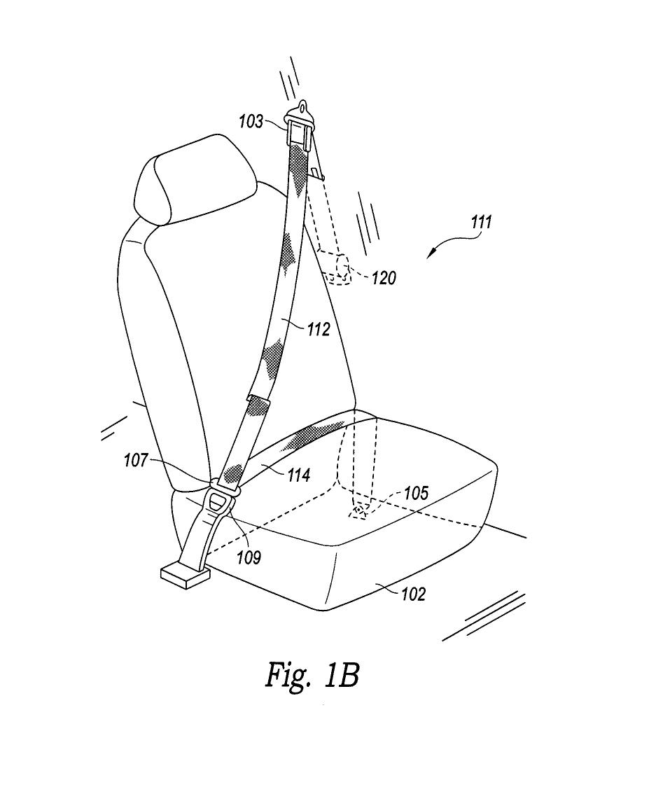

Certain details are set forth in the following description and in FIGS. 1A-6E to provide a thorough understanding of various embodiments of the disclosure. Other details describing well-known structures and systems often associated with seat belts, retractors, and other portions of restraint systems have not been set forth below to avoid unnecessarily obscuring the description of the various embodiments of the disclosure.

Many of the details, dimensions, angles and other features shown in FIGS. 1A-6E are merely illustrative of particular embodiments of the disclosure. Accordingly, other embodiments can add other details, dimensions, angles and features without departing from the spirit or scope of the present technology. In addition, those of ordinary skill in the art will appreciate that further embodiments of the technology can be practiced without several of the details described below.

FIG. 1A is a side view of an occupant 100 secured to a vehicle seat 102 with a restraint system 110 having a first web retractor 120 configured in accordance with an embodiment of the present technology. The restraint system 110 can be a seat belt system used to secure the occupant 100 in, for example, ground vehicles (e.g., automobiles, trucks, off-road vehicles), water vehicles (e.g., boats, ships, jet skis), aircraft (e.g., private and military aircraft), spacecraft, etc. The first web retractor 120 can be fixedly attached to a seat frame 104 by means of bolts and/or other suitable fasteners known in the art, and can include a spring-loaded spool (not shown in FIG. 1A) that carries a shoulder web 112 wound thereon.

In the illustrated embodiment, the restraint system 110 also includes a lap web 114 that can be carried by and deployed from a second web retractor 122 anchored to the seat base 104. The shoulder web 112 and the lap web 114 can be conventional seat belt webs made from woven materials (e.g., nylon) known in the art. In certain embodiments, the webs 112 and 114 can be used in a conventional manner, such as extracting the shoulder web 112 and the lap web 114 from the corresponding retractors 120 and 122 and releasably engaging a connector (not shown) carried by the distal end portions of the webs 112 and 114 into a buckle (not shown) that is anchored to the seat frame 104 or the floor of the vehicle (e.g., on the opposite side of the seat 102 from the second web retractor 122).

FIG. 1B is a side view of a restraint system 111 configured in accordance with another embodiment of the present technology. The restraint system 111 includes features that are at least generally similar in structure and/or function to the restraint system 110 discussed above. The restraint system 111, for example, includes the seat 102, the shoulder web 112, the lap web 114, and the web retractor 120. In the illustrated embodiment, however, the web retractor 120 is fixedly attached to a sidewall portion of the vehicle. The shoulder web 112 slideably passes through a guide 103 before extending downward into the web retractor 120. The lap web 114 is fixedly attached to an anchor 105 on a floor of the vehicle adjacent to the seat 102. The shoulder web 112 and the lap web 114 can be slideably coupled to a belt connector 107 that releaseably engages a buckle 109 anchored to the floor of the vehicle opposite the anchor 105. The wall-mounted retractor 120, like the seat-mounted retractors described above, can facilitate extension and retraction of the shoulder web 112 and the lap web 114. In further embodiments, the retractors 120 and 122 can be mounted directly to the sidewall of the vehicle, to other portions of the vehicle (e.g., the vehicle floor), and/or to other equipment within the vehicle (e.g., a car seat).

Although FIGS. 1A and 1B illustrate two possible configurations of seat belt systems, those of ordinary skill in the art will appreciate that the web retractors disclosed herein can be suitably employed in a wide variety of seat belt systems and vehicles with which seat belt web retractors are used. In other embodiments, for example, the restraint systems 110 and 111 can include additional webs (e.g., additional shoulder webs, crotch webs) and corresponding retractors. Accordingly, those of skill in the art will understand that the web retractors described herein are not limited to use in any particular configuration or arrangement.

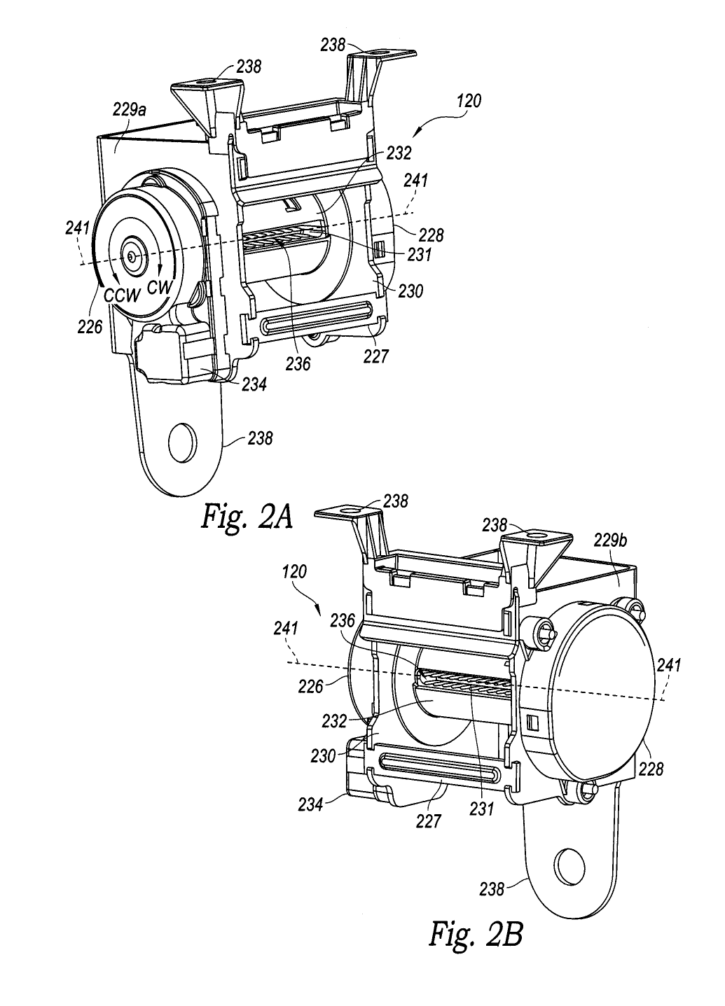

FIGS. 2A and 2B are isometric views of the web retractor 120 configured in accordance with an embodiment of the present technology. Referring to FIGS. 2A and 2B together, the web retractor 120 can include a locking mechanism cover or housing 226 and a spring assembly cover or housing 228 attached to opposite side walls 229 (identified individually as a first sidewall 229a (FIG. 2A) and a second sidewall 229b (FIG. 2B)) of a retractor housing or frame 230. The locking mechanism housing 226 and the spring assembly housing 228 can be attached to the sidewalls 229 of the retractor frame 230 using screws, mating interfaces, and/or other suitable attachment means known in the art. The locking mechanism housing 226 and the spring assembly housing 228 can be formed from plastic (e.g., injection-molded plastic) and/or other suitable materials for housing the retractor mechanisms. The retractor frame 230 can be made from metal (e.g., stamp-formed from a metal sheet or plate, cast, forged, etc.), plastic, and/or other suitable materials known in the art. In various embodiments, the retractor frame 230 can include one or more reinforcement features, such as tie bars 227 spaced between opposing sidewalls 229 of the retractor frame 230.

A spool 232 having a spring-loaded shaft 231 can extend between the sidewalls 229 of the retractor frame 230, and can be operably coupled to retractor mechanisms (not shown) stored within the locking mechanism housing 226 and the spring assembly housing 228. The shaft 231 and the spool 232 can be made from metal, plastic, and/or other suitable materials known in the art. The shaft 231 can rotate about an axis 241 in a first direction to retract and wind a strap or web (e.g., the shoulder or lap webs 112 and 114 of FIGS. 1A and 1B) around the spool 232. The shaft 231 can also rotate about the axis 241 in the opposite direction to allow extraction of the web from the retractor 120. In the embodiment illustrated in FIGS. 2A and 2B, the spool 232 includes an opening or slot 236 that receives an end portion of the web to secure the web to the spool 232 with internal engagement features (not shown). In other embodiments, the retractor 120 can include other features known in the art to fasten the web to the spool 232. The web can be wound onto the spool 232 in a clockwise direction CW (FIG. 2A), and in other embodiments the web can be wound onto the spool 232 in the counterclockwise direction CCW. In various aspects of the technology, the retractor 120 can be configured to house webs having various lengths. The retractor 120, for example, can be configured to house webs having lengths from approximately 60 inches to approximately 140 inches, such as about 120 inches.

In the illustrated embodiment, the retractor 120 further includes a plurality of anchoring features 238 with apertures configured to receive bolts and/or other suitable fasteners to fixedly attach the retractor 120 to a seat base (e.g., the seat base 104 shown in FIG. 1A), a vehicle sidewall (e.g., as shown in FIG. 1B), and/or other portions of a vehicle. In other embodiments, the retractor frame 230 can be anchored to the vehicle using other suitable attachment means known in the art.

As described in greater detail below, the locking mechanism housing 226 covers or contains a locking mechanism that is actuated by web and/or vehicle inertia sensors to block rotation of the shaft 231 and prevent further extraction of the web. The web inertia sensor can trigger when web extraction accelerates the spool 232 above a predetermined threshold. The vehicle inertia sensor can trigger under rapid deceleration (e.g., during a crash), or when the retractor 120 achieves a particular orientation (e.g., inverted). The vehicle inertia sensor can include a sensor ball (e.g., a steel ball) that is movably contained in a ball cavity or compartment 234 formed in the locking mechanism housing 226. In various embodiments, the locking mechanism housing 226 can contain a load limiting feature that releases a limited amount of the web after the shaft 231 has been locked to reduce the load applied by the web on the occupant during a violent crash.

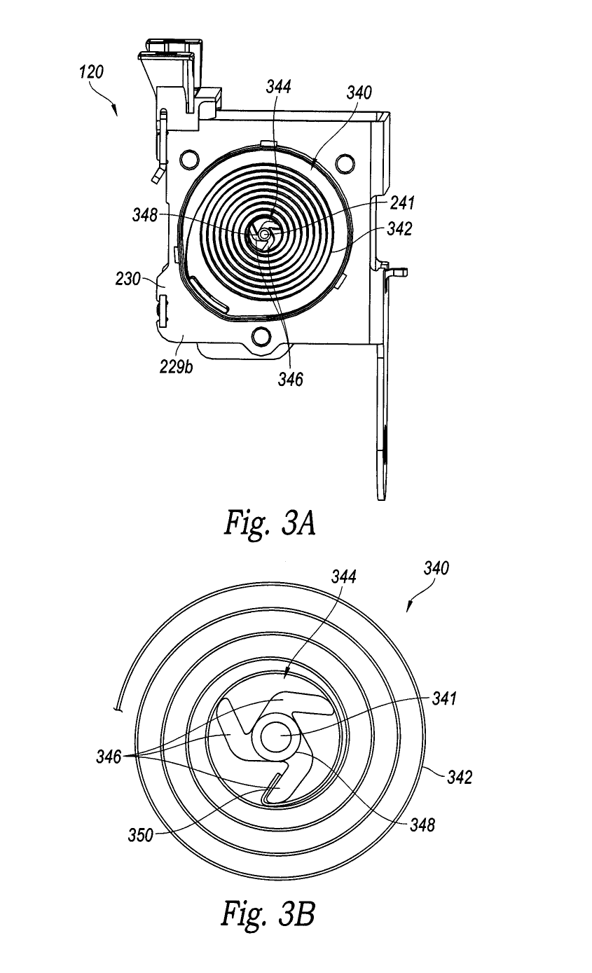

FIG. 3A is a side isometric view of the retractor 120 with the spring housing 228 (FIGS. 2A and 2B) removed to illustrate a spring assembly 340 configured in accordance with an embodiment of the present technology, and FIG. 3B is an enlarged view of a portion of the spring assembly 340. The spring assembly 340 can include a biasing member such as a driving coil or spring 342 that is wound concentrically around a spring engagement feature 344 coupled to the shaft 231 (FIGS. 2A and 2B). The driving spring 342 can apply a torque to the shaft 231, which in turn exerts tension on the web during extension and drives web retraction. The driving spring 342 can be made from an elastic metal (e.g., hardened steel) and/or other suitable material that can store sufficient energy to spring-load the shaft 231.

As shown in FIGS. 3A and 3B, the spring engagement feature 344 can include one or more hooks 346 positioned circumferentially around an axle 348. In the illustrated embodiment, for example, the spring engagement feature 344 includes three hooks 346 oriented in a clockwise direction. In other embodiments, however, the spring engagement feature 344 can include a greater or smaller number of hooks 346 and/or the orientation of the hooks 346 can differ. In further embodiments, the spring engagement feature 344 can include other curved or angled features positioned circumferentially about the rotatable axle 348. The spring engagement feature 344 can be made from a suitable plastic, metal, and/or other material that can withstand loads applied to the driving spring 342 during retraction and extension of the web.

As shown in FIG. 3B, the hooks 346 can be configured to receive and/or engage a bent or otherwise deformed end portion 350 of the driving spring 342. During installation, the end portion 350 can be positioned proximate to the spring engagement feature 344 as it is rotated about the axle 348 in a direction corresponding to the orientation and/or shape of the hooks 346 (e.g., clockwise in the illustrated embodiment). The end portion 350 will eventually catch on one of the hooks 346, and continued rotation of the spring engagement feature 344 can wind the remainder of the driving spring 342 about the axle 348. In other embodiments, the driving spring 342 can be pre-wound and subsequently placed over the spring engagement feature 344 to engage the end portion 350 with one of the rotating hooks 346. The spring engagement feature 344, therefore, reduces or eliminates the need to manually connect the driving spring 342 with a slot or other aperture at an end of the shaft 231, and thereby facilitates spring installation.

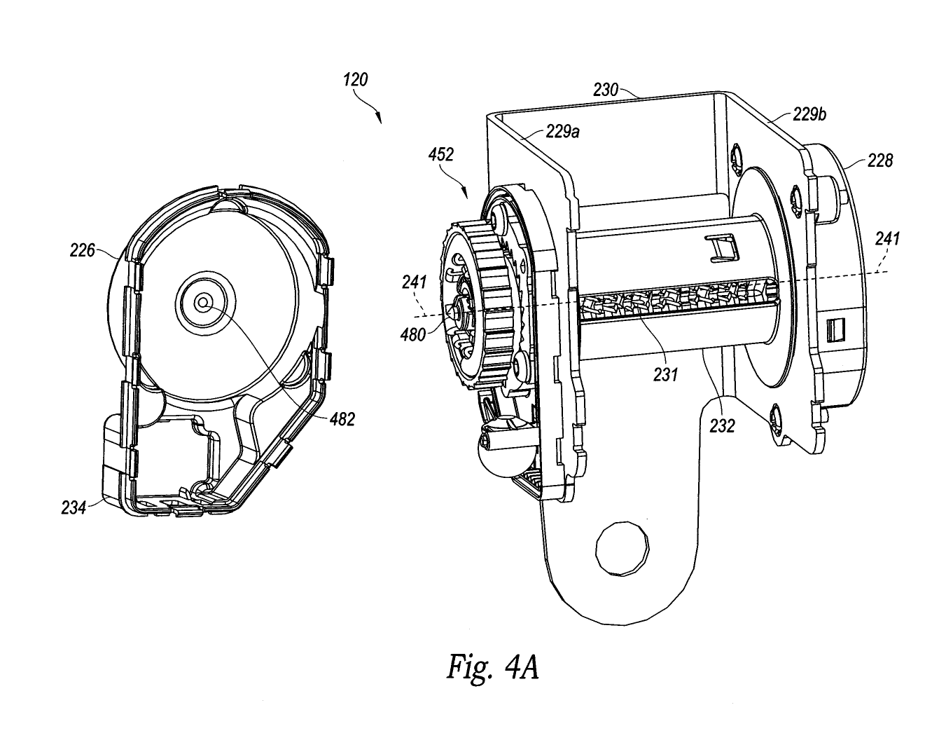

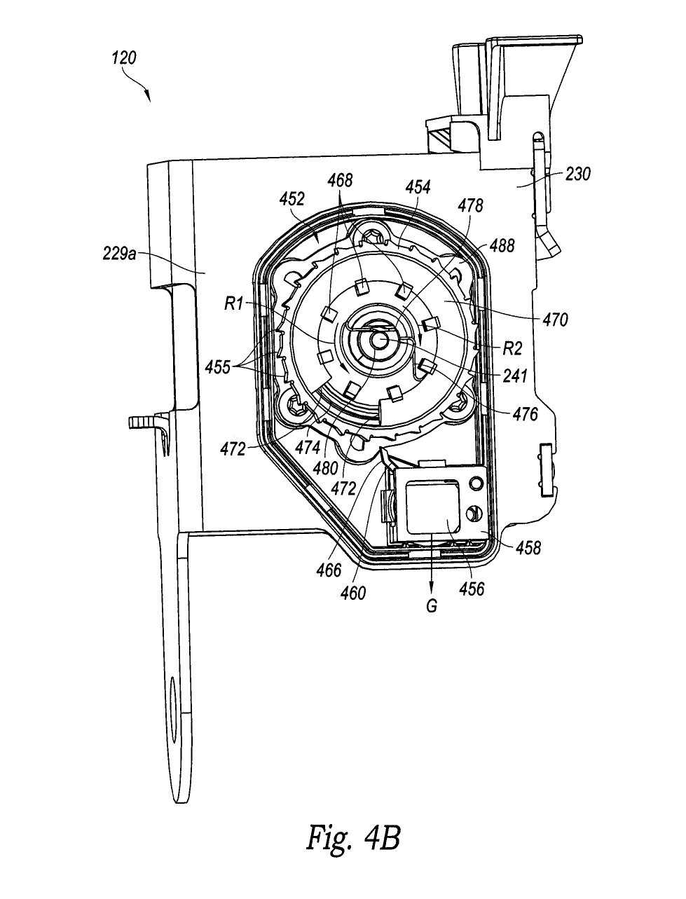

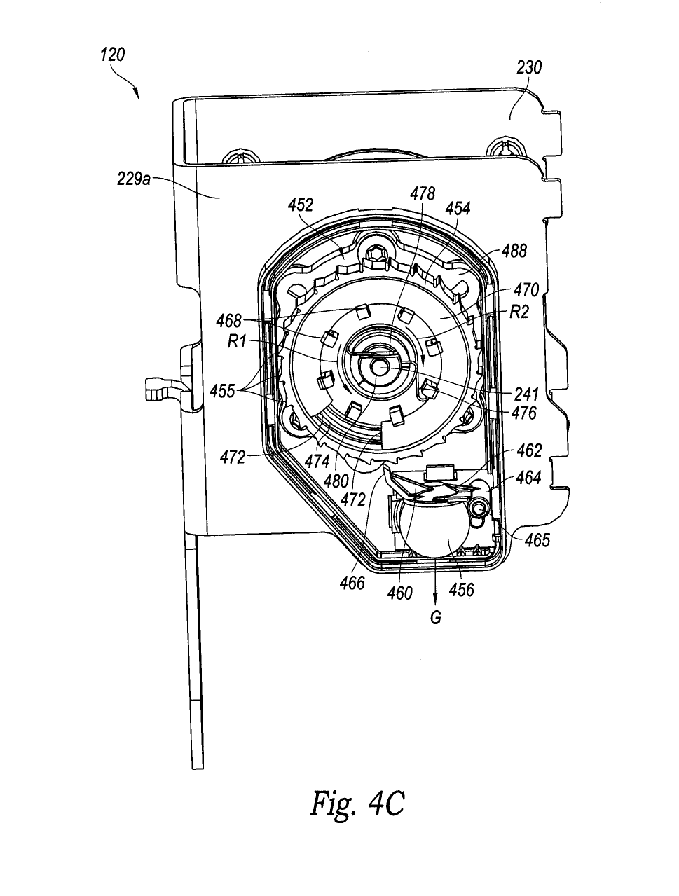

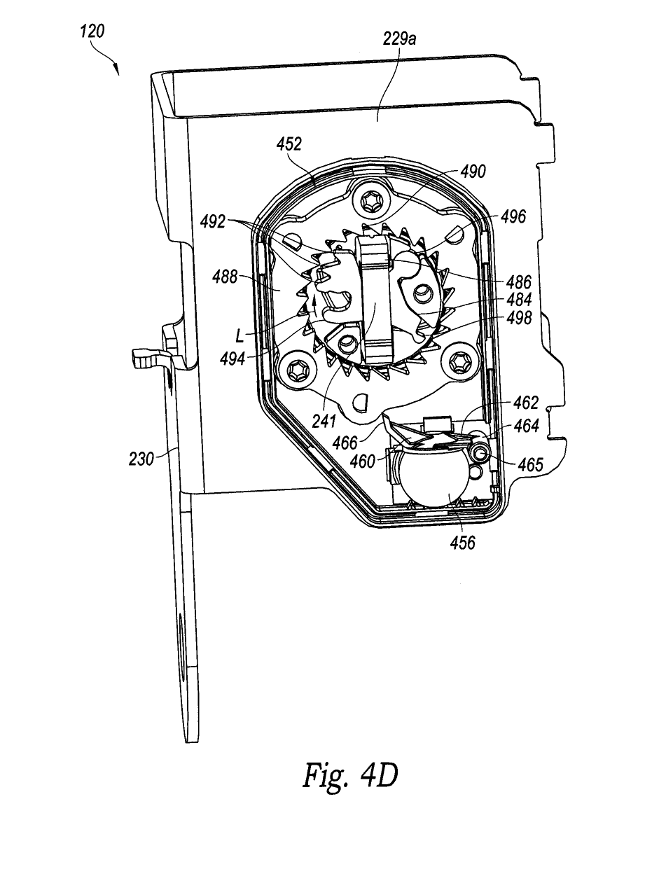

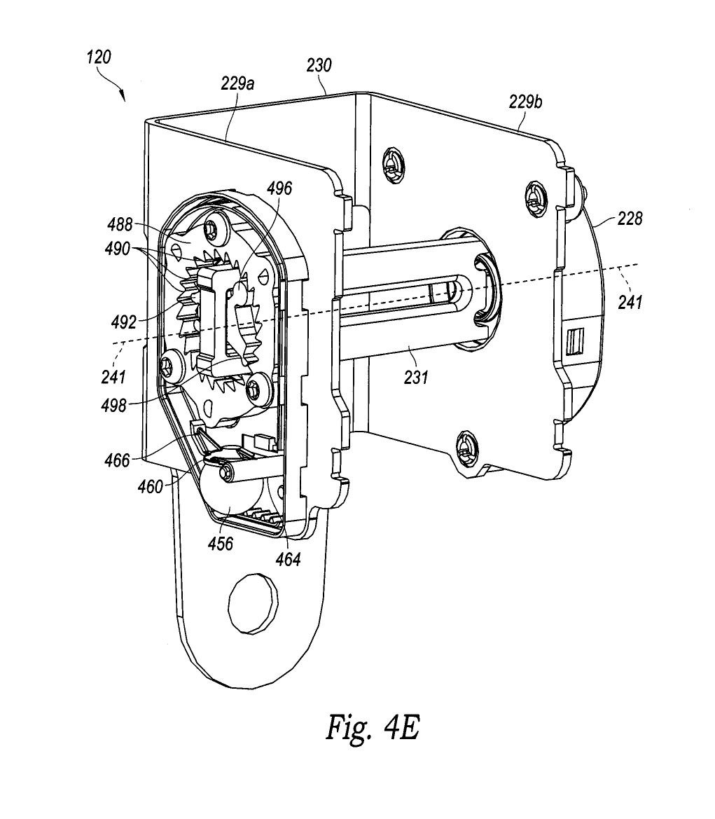

FIGS. 4A-4C are a series of views of the retractor 120 of FIGS. 2A and 2B illustrating a locking mechanism 452 configured in accordance with an embodiment of the present technology. More specifically, FIG. 4A is a partially exploded isometric view of the retractor 120 showing a conical protrusion 480 that projects from the locking mechanism 452. The conical protrusion 480 can be part of a retaining feature coupled to the shaft 231 such that the two are coaxially aligned along the axis 241. The locking mechanism cover 226 can include a complimentary conical bearing 482 that supports the conical protrusion 480 and enables axial rotation of the shaft 231 and other features (e.g., the spring assembly 340, the spool 232) operatively coupled to the shaft 231. In other embodiments, the conical protrusion 480 and the conical bearing 482 can be reversed such that the locking mechanism cover 226 includes the conical protrusion 480 and the locking mechanism 452 include a conical bearing 482. Regardless of the orientation, the conical bearing 482 can incur less friction than other types of bearings, and thus enhances the rotation of the shaft 231 and the efficiency of the retractor 120. In various embodiments, the opposite end of the shaft 231 proximate to the spring assembly 340 (FIGS. 3A and 3B) can also rotate about a conical bearing to further decrease friction and increase retractor efficiency. In other embodiments, the shaft 231 can rotate about differently shaped bearings and/or other rotational supports.

FIGS. 4B and 4C are side views of the retractor 120 with the locking mechanism housing 226 (FIG. 4A) removed to illustrate various portions and operational aspects of the locking mechanism 452. Referring to FIGS. 4B and 4C together, the locking mechanism 452 can include an inertia wheel, flywheel, or lock wheel 454 that is operably coupled to the shaft 231 (FIG. 4A) and rotates about the conical protrusion 480. In the illustrated embodiment, the lock wheel 454 rotates in a first direction R1 when the web is pulled out from the retractor 120. Conversely, when the spring-loaded shaft 231 draws the web back into the retractor 120, the lock wheel 454 rotates in the opposite direction R2. In other embodiments, the directions of the lock wheel 454 associated with retraction and extraction can be reversed. The lock wheel 454 can be formed from suitable materials known in the art, such as injection molded plastics, nylon, metal, Delrin®, etc.

In the illustrated embodiment, the lock wheel 454 includes a plurality of teeth 455 positioned along a peripheral surface of the lock wheel 454 and a plurality of projections 468 arranged circumferentially around the face of the lock wheel 454 inward from the teeth 455. The projections 468 can have hook-like shapes that form an annular channel configured to receive an inertial body 470. The inertial body 470 can be made from iron, stainless steel, and/or other suitable materials known in the art, and can have a semicircular shape with end portions 472 spaced apart from one another. A ridge 474 protruding from the lock wheel 454 can engage the end portions 472 of the inertial body 470 to limit or prevent the inertial body 470 from shifting in a circumferential direction about the lock wheel 454. Additionally, the ridge 474 can be used to orient the inertial body 470 with respect to the lock wheel 454 during installation. In various embodiments, the projections 468 and the ridge 474 can be made from a resilient material such that the inertial body 470 can be pressed and snapped into engagement with the lock wheel 454. In other embodiments, the inertial body 470 can be attached to the lock wheel 454 using other suitable fastening methods known to those skilled in the art. In further embodiments, the inertial body 470 can have a different shape (e.g., a disc) than shown in the illustrated embodiment or the lock wheel 454 can itself serve as an inertial body.

The locking mechanism 452 can further include a return spring 476 (e.g., a helical spring), a first end portion of which is suspended on one of the projections 468 and a second end portion of which is suspended in an aperture 478 on the conical protrusion 480 over the lock wheel 454. In other embodiments, the first end portion of the spring 476 can attached to other portions of the lock wheel 454 and the second end portion can attach to other features positioned over the lock wheel 454. The spring 476 can bias the lock wheel 454 in an unlocked position (i.e., toward the retractor frame 230). When the web is pulled from the spool 232 faster than a predetermined threshold, the inertial body 470 overcomes the spring bias, and drives the lock wheel 454 outward away from the retractor frame 230. As described in greater detail below, the outward movement of the lock wheel 454 allows an underlying pawl to pivot and engage with corresponding teeth on a stationary lock ring or gear 488 to stop the rotation of the shaft 231. Accordingly, the inertial body 470 serves as the web inertia sensor that triggers the locking mechanism 452 when the acceleration of the spool 232 rises above a predetermined threshold.

As further shown in FIGS. 4B and 4C, the locking mechanism 452 can also include a sensor mass or ball 456 that is operably positioned between a support cup or basket 458 and a pivotal lock arm or lever 460 and is sensitive to vehicle movement and orientation. In various embodiments, the ball 456 can be formed from suitable metallic materials, such as iron, stainless steel, chrome plated steel, etc. The basket 458 is removed in FIG. 4C to illustrate that the lock arm 460 can have a proximal end portion 462 that is pivotally received in a socket 464 and is configured to pivot about an axis 465 (e.g., about a pin). When the sensor ball 456 moves relative to the basket 458 toward a distal end portion 466 of the lock arm 460, it displaces the lock arm 460, causing the distal end portion 466 to pivot toward the lock wheel 454. The distal end portion 466 is configured to engage one or more of the plurality of teeth 455 on the lock wheel 454. The lock arm 460, the basket 458 and/or various portions thereof can be made from plastic, nylon, and/or other suitable materials known in the art.

The ball 456 is generally seated in the basket 458 when gravity is acting in a general direction G on the retractor 120. If the vehicle experiences a rapid deceleration or acceleration of sufficient magnitude and direction, or if the retractor 120 moves to a sufficiently different orientation (e.g., when the retractor 120 is inverted), the ball 456 will move relative to the basket 458 to pivot the lever arm 460 into engagement with one or more of the teeth 455 on the lock wheel 454 and stop its rotation. The relative movement between the stopped lock wheel 454 and the rotating shaft 231 causes the inertial body 470 to overcome the spring bias and drive the lock wheel 454 axially outward. Similar to the web initiated locking, the displaced lock wheel 454 allows the underlying pawl to engage the lock ring 488 and stop rotation of the shaft 231. The ball 456, therefore, functions as the vehicle inertia sensor that actuates the locking mechanism 452 upon the occurrence of an unacceptable acceleration, deceleration, or orientation of the vehicle. Accordingly, the locking mechanism 452 can be actuated independently by either the vehicle inertia sensor (i.e., the ball 456), the web inertia sensor (e.g., the inertial body 470), or both. In other embodiments, the retractor 120 can include only one of the web and vehicle inertia sensors and/or include other activation means known in the art.

In the illustrated embodiment, the ball 456 of the vehicle inertia sensor moves generally perpendicular to gravity G to trigger the locking mechanism 452 during an accident or other rapid deceleration event. In other embodiments, however, the retractor 120 can be oriented at a different angle (e.g., 80°, 115°, etc.) with respect to the direction of gravity G, and the vehicle inertia sensor can be positioned in an appropriate orientation to allow the ball 456 to trigger the locking mechanism 452 during rapid decelerations, accelerations, and/or changes in orientation.

FIGS. 4D and 4E are side and isometric views, respectively, of the locking mechanism 452 with the lock wheel 454 and the spool 232 (FIGS. 4A-4C) removed to show the stationary lock ring 488 with a plurality of teeth 490 fixedly attached to the sidewall 229a of the retractor frame 230. In the illustrated embodiment, the locking mechanism 452 further includes an inertial counterweight 484 (e.g., a lock pawl) that is pivotally coupled to the shaft 231. The counterweight 484 can include an arm 494, a pivot portion 496, and one or more teeth 492. The teeth 492 on the counterweight 484 can be configured to engage the teeth 490 on the lock ring 488. The shaft 231, the counterweight 484, the lock ring 488, and/or various portions thereof can be formed from metallic materials (e.g., stainless steel, iron) and/or other suitable materials known in the art.

In the unlocked position, protrusions and/or other fasteners (not shown) on the underside of the lock wheel 454 can engage the arm 494 of the counterweight 484 to restrain its movement. When the locking mechanism 452 is triggered by the vehicle inertia sensor (e.g., the sensor ball 456 of FIGS. 4A-4C) and/or the web inertia sensor (e.g., inertial body 470 of FIGS. 4A-4C), the lock wheel 454 is pulled outward. This releases the arm 494 such that the counterweight 484 can rotate radially outward about the pivot portion 496 in the direction of the arrow L (FIG. 4D). One or more of the teeth 492 on the counterweight 484 can swing into engagement with the corresponding teeth 490 on the lock ring 488, and thereby stop the rotation of the shaft 231. In some embodiments, the counterweight 484 is shaped such that the teeth can fully engage the teeth 490 on the lock ring 488. In other embodiments, the counterweight 484 is shaped such that the counterweight teeth 492 only partially engage the lock ring teeth 490. When the triggering force (e.g., web acceleration, vehicle deceleration, vehicle orientation) falls below the predetermined threshold, the counterweight 484 can swing back to its disengaged state and once again permit rotation of the shaft 231.

In the embodiment illustrated in FIGS. 4D and 4E, the locking mechanism 452 also includes a load limiting feature 498 that allows further pay-out of the web from the retractor 120 after the shaft 231 has been locked. In various embodiments, such as the embodiment shown in FIGS. 4D and 4E, the load limiting feature 498 can be an area of decreased shear or bending strength that is designed to break when a threshold level of force is applied to the web. This allows the shaft 231 to rotate slightly, release some of the web, and thereby limit the load applied by the web on the occupant's body. In other embodiments, the shaft 231 can be configured as a torsion bar that twists when a predetermined load is applied. Such a torsion bar will hold its shape and lock along with the locking mechanism 452 in less severe accidents, but will twist a controlled amount to allow further pay-out of the web from the retractor 120 when forces rise above a predetermined threshold. In other embodiments, the retractor 120 can include other load limiting means known in the art.

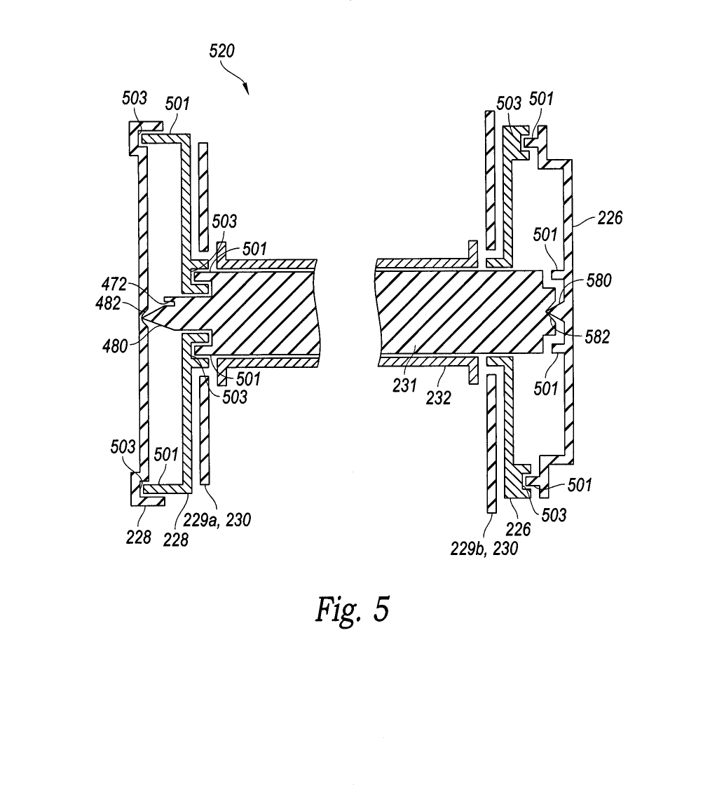

FIG. 5 is a partial side cross-sectional view of a web retractor 520 configured in accordance with another embodiment of the present technology. The web retractor 520 can have features at least generally similar in structure and function to the features of the web retractor 120 described above. The retractor 520, for example, includes the locking mechanism housing 226, the spring assembly housing 228, the retractor frame 230, the spool 232, and the shaft 231. The retractor 520 also includes the conical protrusion 480 and the corresponding conical bearing 482 at the end of the shaft 231 proximate to the lock mechanism (not shown for clarity), and a second conical protrusion 580 with a corresponding second conical bearing 582 at the opposite end of the shaft 231 proximate to the spring assembly (also not shown for clarity). Rather than being positioned on the shaft 231, the second conical protrusion 580 extends from the spring assembly housing 226 and the shaft 231 includes the second conical bearing 582.

In the illustrated embodiment, the retractor 520 further includes a plurality of projections 501 and indentations 503 positioned on the locking mechanism housing 226, the spring assembly housing 228, the retractor frame 230, the shaft 231, and/or the spool 232. The projections 501 and indentations 503 can be circular, rectangular, and/or other suitable shapes, and can be positioned concentrically around the perimeter of the housings 226 and 228, the retractor frame 230, and/or other portions of the retractor 520. The projections 501 and indentations 503 can form a tortuous path that substantially reduces or prevents dirt, sand, mud, and/or other debris from entering the housings 226 and 228 and disrupting the functions of the locking mechanism 452, the shaft 231, the conical bearing 482, and/or the spring assembly 340. The tortuous path can, for example, limit the debris collected inside the ball compartment 234 (FIG. 2A) that could prevent the ball 456 from driving the lever arm 460 into engagement with the lock wheel 454. Debris build up can also cause premature locking of the shaft 231 by falsely triggering the locking mechanism 452. Accordingly, the tortuous path defined by the projections 501 and indentations 503 can reduce the likelihood that the retractor 120 will malfunction. In other embodiments, tortuous paths can be formed on other portions of the retractor 120 and/or around selected portions susceptible to debris build-up. In further embodiments, the retractor 120 can include other features that can prevent debris from interfering with the mechanisms of the retractor 120 and/or remove debris trapped within the retractor 120.

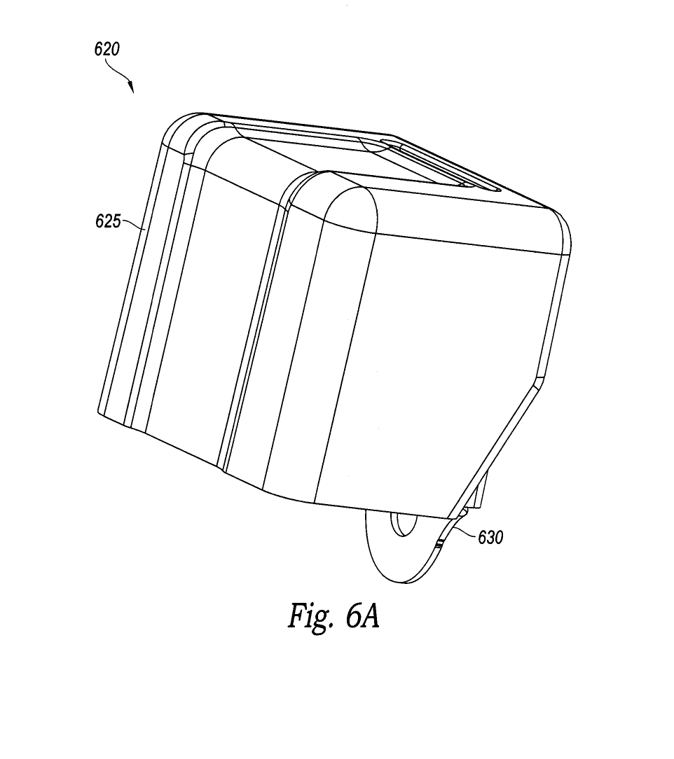

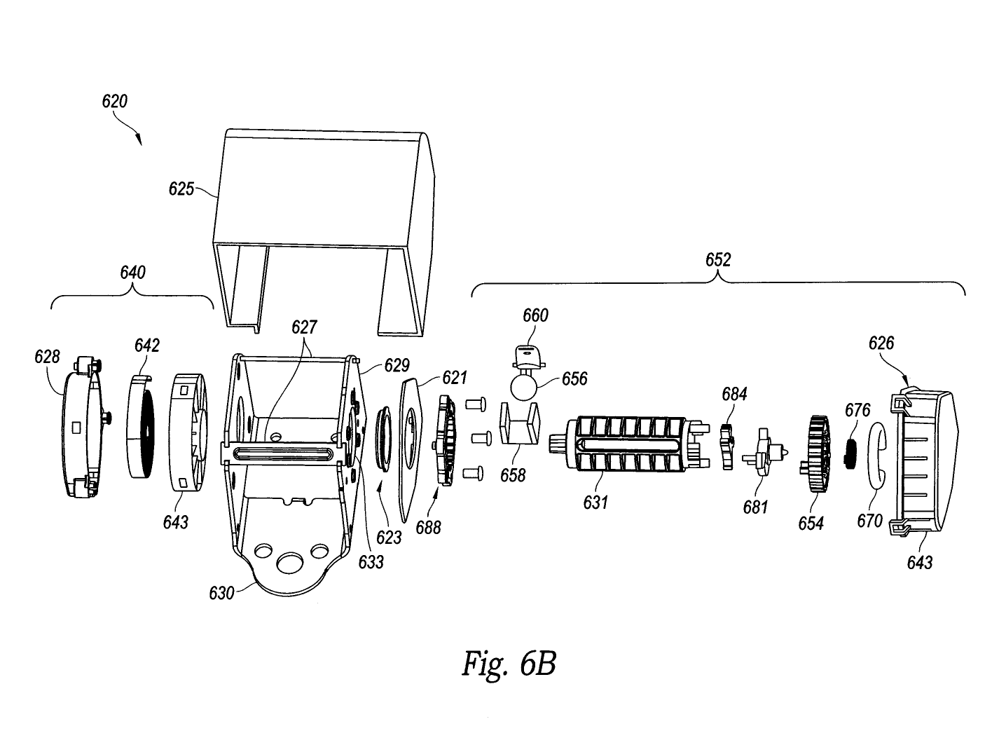

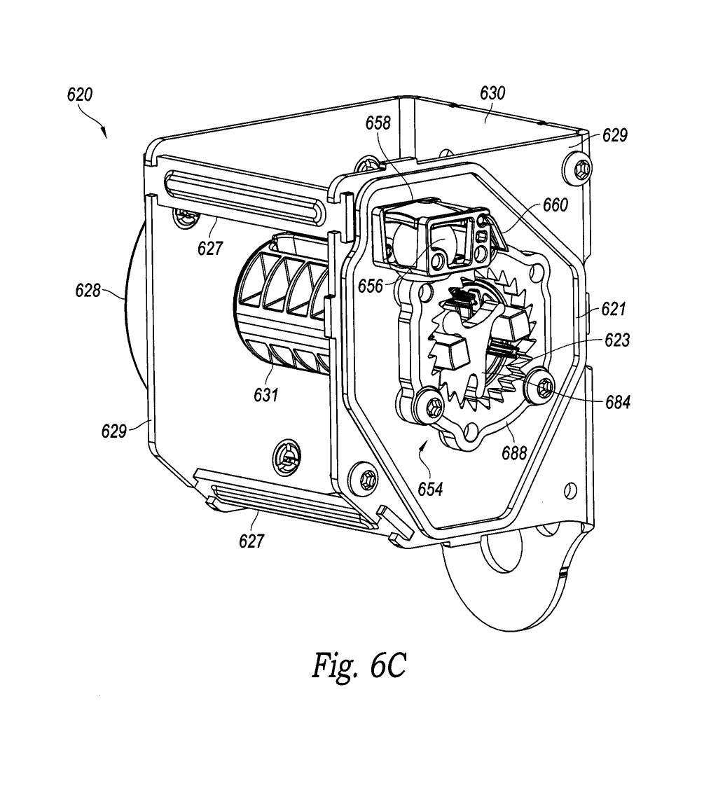

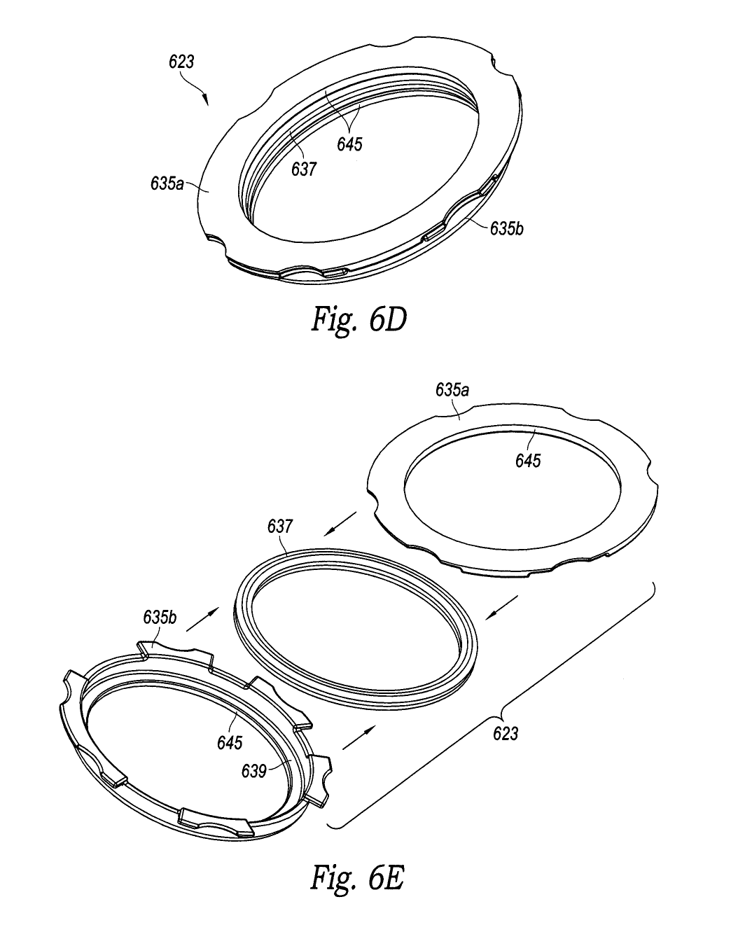

FIGS. 6A and 6B are isometric and exploded isometric views, respectively, of a retractor 620 configured in accordance with a further embodiment of the present technology, and FIG. 6C is an isometric side view illustrating internal features of the retractor 620. The retractor 620 can include features at least generally similar in structure and function to the features of the retractors 120 and 520 discussed above. As shown in FIG. 6B, for example, the retractor 620 can include a retractor frame 630 with tie bars 627 extending between opposing sidewalls 629 and a shaft 631 (shown positioned within a shaft sleeve) rotatably extending between the opposing sidewalls 629. A spring assembly 640 and a locking mechanism 652 can be positioned on opposite sidewalls 629 and operably coupled to the shaft 631. The spring assembly 640 can include a motor or driving spring 642 mounted to a spring housing 643 and enclosed in a spring assembly cover or casing 628. The locking mechanism 652 can include a lock gear 688, a load limiting feature 684 (e.g., a lock pawl), a web inertia sensor (e.g., a retaining structure 681 carrying a lock wheel 654, a web sense mass 670, and a spring 676), and a vehicle inertia sensor (e.g., a vehicle sense mass 656 carried by a basket 658 and acting on a lever 660). A locking mechanism cover or casing 626 can be positioned over the locking mechanism 652 to shield the underlying sensing features (e.g., the vehicle and web inertia sensors) from debris and other potentially harmful elements from the external environment.

As shown in FIGS. 6A and 6B, the retractor 620 can further include a retractor housing or cover 625 that at least partially encases the retractor frame 630, spring assembly cover 628, and locking mechanism cover 626, and forms an additional barrier between the internal components of the retractor 620 (e.g., the spring assembly 640 and the locking mechanism 652) and the external environment. The retractor cover 625 can be a made from plastic and/or other durable materials, and may be shaped (e.g., overmolded) to receive the retractor 620. In certain aspects of the technology, the retractor cover 625 can have generally smooth interior surfaces and/or a plurality of ribs or other suitable structures that attach the retractor cover 625 to the retractor 620 with a minimal contact area. The smooth surfaces of the retractor cover 625 and limited contact area between the retractor cover 625 and the retractor 620 can facilitate the flow of liquid and other debris (e.g., dirt, mud, etc.) through the retractor cover 625 and out the open bottom of the retractor cover 625. This can prevent the build up of debris on the webbing and/or inside the retractor cover 625 which may interfere with the operation of the retractor cover 625. The retractor cover 625 can also further inhibit dirt and other debris from interfering with the spring assembly 640 and the locking mechanism 652 and shield the retractor 620 from potentially harmful impacts (e.g., that may occur during a vehicle accident). In addition, the retractor cover 625 can prevent liquids (e.g., water) from coming between the shaft 631 and spool sleeve.

The retractor 620 shown in FIGS. 6A-6C also includes various features that partially or fully seal the locking mechanism 652 within the enclosure formed by the locking mechanism cover 626 and the sidewall 629 of the retractor frame 630. As shown in FIGS. 6B and 6C, for example, the retractor 620 can include a suitable gasket or other seal feature 621 that is configured to prevent liquids (e.g., water) and other debris (e.g., mud, dust, etc.) from entering the casing 626 at the interface between the sidewall 629 and the locking mechanism cover 626 (FIG. 6B) and interfering with the locking mechanism 652. As shown in FIG. 6C, the seal feature 621 can be a flat gasket (or a flat gasket with a raised lip as illustrated) that sits flush against the sidewall 629 of the retractor frame 630 beneath the components of the locking mechanism 652 (e.g., under the lock ring 688, the vehicle inertia sensor, etc.). The seal feature 621 can include openings configured to receive fasteners (e.g., screws) that attach the locking mechanism 652 to the retractor frame 630 and/or protruding structures that extend around the fasteners to enhance the seal around the locking mechanism 652. In other embodiments, the seal feature 621 can be insert molded, injection molded (e.g., two-shot molded), and/or otherwise formed to around the locking mechanism 652.

When the locking mechanism cover 626 (FIG. 6B) is mounted over and mated with the seal feature 621, the seal feature 621 prevents liquids from accessing the locking mechanism 652 and interference with the vehicle and web inertia sensors. In other embodiments, the seal feature 621 can have other suitable arrangements that inhibit liquids and/or other debris from interfering with the locking mechanism 652. The seal feature 621, for example, can include a gasket that provides a seal at interface between the locking mechanism housing 626 and the retractor frame 630, but has a large central opening through which the locking mechanism 652 is attached to the retractor frame 630. In further embodiments, the seal feature 621 (e.g., a gasket) can be integrated with locking mechanism cover 626 as an insert-molded or injection-molded (e.g., two-shot injection-molded) component (e.g., rather than a separate component).

In the illustrated embodiment, the retractor 620 further includes a sealed bearing 623 configured to prevent liquids and/or other debris from accessing the enclosed locking mechanism 652 via the interface between the shaft 631 and the retractor frame 630. As shown in FIG. 6B, the sealed bearing 623 can be positioned at an aperture or opening 633 of the retractor frame 630 to carry the shaft 631. The sealed bearing 623 can be held in the opening 633 using pins, clips, threads, and/or other suitable means known to those skilled in the art.

FIGS. 6D and 6E are enlarged isometric and exploded isometric views, respectively, of the sealed bearing 623 configured in accordance with an embodiment of the present technology. Referring to FIGS. 6D and 6E together, the sealed bearing 623 can include an upper or first bearing member 635a, a lower or second bearing member 635b, and a sealing ring or feature 637 (e.g., an o-ring, a square or rectangular seal, a hydraulic seal, etc.) positioned between the first and second bearing members 635a and 635b. The first and second bearing member 635a and 635b can be made from steel, other metals, durable plastics, and/or other suitable bearing materials, and can be attached to one another to trap the sealing feature 637 therebetween using interlocking surfaces (e.g., complimentary protrusions and apertures), adhesives, and/or other suitable connection mechanisms known in the art. As shown in FIG. 6E, the second bearing member 635b can include a cupped or recessed portion 639 shaped to receive the sealing feature 637. In other embodiments, the first and second bearing members 635a and 635b can have other suitable configurations that retain the sealing feature 637. The sealing feature 637 can have various different cross-sectional shapes, such as round, rectilinear, X-shaped, etc. In use, bearing surfaces 645 of the bearing members 635 can interact with that shaft 631 (FIG. 6B) to allow the shaft to rotate therein while providing a liquid-tight seal that prevents liquids and debris from accessing the enclosed locking mechanism 652 via the retractor frame-to-bearing interface and the shaft-to-bearing interface. In other embodiments, the sealed bearing 623 can be made from a single bearing member (e.g., a gland bearing) configured to receive the sealing feature 637, or the sealing feature 637 can be insert or injection molded into a portion of a bearing member (e.g., into a gland bearing). In further embodiments, the retractor 630 can include other gaskets, seals, and features that form a seal around the shaft 631 (FIG. 6B). In various embodiments, the shaft 631 can be lubricated to enhance the seal between the bearing 623 and the shaft 631.

Referring back to FIG. 6B, in certain aspects of the technology the locking mechanism cover 626 can include an optional drain hole or feature 643 that allows liquids to exit the enclosure around the locking mechanism 652. The drain feature 643 may be positioned at a lower or bottom portion of the locking mechanism cover 626 as shown in FIG. 6B to facilitate liquid removal via gravity. In various embodiments, the drain feature 643 may include a one-way valve, baffle, and/or other feature that allows liquid to exit the enclosed area around the locking mechanism 652, but prevents liquid from entering the enclosure. In the event liquid bypasses the sealing feature 621 and/or the sealed bearing 623, the drain feature 643 allows the liquid to exit the enclosure and prevents interference with the functions of the sensing features stored therein. In various embodiments, the locking mechanism 652 may be only partially sealed between the locking mechanism cover 626 and the retractor frame 630 or the retractor 620 may not include a seal, and the drain feature 643 can serve to provide a way to remove liquids from the locking mechanism 652. The drain feature 643, therefore, may be included in retractors that do necessitate a complete liquid seal and/or the tight tolerances of the tortuous path described with reference to FIG. 5 to provide a liquid release when the retractor is in atypical environments (e.g., splashed with water).

As shown in FIG. 6C, in further aspects of the technology the vehicle sensor mass 656 and the associated vehicle inertia sensor assembly (e.g., the lever 660 and the basket 658) can be positioned at a top or upper portion of the retractor 620 (i.e., vertically above the lock gear 688). In the event the enclosure formed around the locking mechanism 652 becomes flooded, any air bubble that forms would naturally do so at the upper portion of the enclosure (e.g., around the vehicle sensor mass 656). The configuration shown in FIG. 6C, therefore, allows the vehicle inertia sensor to remain effective even when liquid enters the enclosure around the locking mechanism 652 (e.g., when the enclosure around the locking mechanism 652 is not fully sealed).

From the foregoing, it will be appreciated that specific embodiments have been described herein for purposes of illustration, but that modifications may be made without deviating from the spirit and scope of the various embodiments of the disclosure. The inertial body 470 shown in FIGS. 4A-4C, for example, has a circular cross-sectional shape. In other embodiments, however, the cross-sectional shape of the inertial body 470 can be rectangular, square, oval, and/or other suitable shapes. Additionally, the conical protrusion 480 shown in FIGS. 4A-4C is aligned with the axis 241 of the shaft 231, but it can be offset from the axis 241 in other embodiments. Moreover, specific elements of any of the foregoing embodiments can also be combined or substituted for elements in other embodiments. The web retractors 120 and 620 described in FIGS. 1A-4E and 6A-6E, for example, can include the projections 501 and indentations 503 illustrated in FIG. 5. Certain aspects of the disclosure are accordingly not limited to automobile or aircraft systems. Furthermore, while advantages associated with certain embodiments of the disclosure have been described in the context of these embodiments, other embodiments may also exhibit such advantages, and not all embodiments need necessarily exhibit such advantages to fall within the scope of the technology. Accordingly, the disclosure is not limited except as by the appended claims.

I/we claim:

1. An apparatus for retracting a seat belt web, the apparatus comprising:
a frame having a first sidewall and a second sidewall opposite the first sidewall;
a spool having a spring-loaded shaft extending between the first and second sidewalls;
a locking mechanism positioned proximate the first sidewall of the frame and operably coupled to the shaft, the locking mechanism having a sensor configured to trigger the locking mechanism to prevent rotation of the shaft; and
a cover enclosing the locking mechanism, wherein the cover and the first sidewall form a liquid-sealed enclosure around the locking mechanism.

2. The apparatus of claim 1, further comprising a sealing feature compressed between the cover and the first sidewall, the sealing feature being configured to form a seal at an interface between the first sidewall and the cover.

3. The apparatus of claim 2 wherein the sealing feature is a gasket extending between the first sidewall and the locking mechanism.

4. The apparatus of claim 1, further comprising a sealed bearing rotatably supporting the shaft on the first sidewall of the frame, wherein the sealed bearing includes a seal portion and a bearing portion, and wherein the seal portion is configured to form a seal at between the shaft and the frame.

5. The apparatus of claim 4 wherein the sealed bearing comprises:
a first bearing member;
a second bearing member attached to the first bearing member; and
a sealing feature disposed between the first and second bearing members.

6. The apparatus of claim 1 wherein the cover includes a drain feature configured to allow liquid to exit the enclosure and prevent liquid from entering the enclosure.

7. The apparatus of claim 6 wherein the drain feature includes a baffle.

8. The apparatus of claim 1, further comprising a retractor cover extending at least partially around the frame, spool, locking mechanism, and cover.

9. The apparatus of claim 1, further comprising a spring assembly positioned proximate the second sidewall of the frame and operably coupled to the shaft, wherein the spring assembly includes:
a driving spring configured to apply a torque to the shaft to drive web retraction and exert tension on the seat belt web during web extension; and
a spring engagement feature attached to an end portion of the driving spring, the spring engagement feature configured to engage the end portion of the driving spring upon rotation of the spring engagement feature in a first direction relative to the driving spring, the spring engagement feature further configured to bypass the end portion of the driving spring upon rotation of the spring engagement feature in a second direction opposite the first direction.

10. The apparatus of claim 1 wherein the sensor is a web inertia sensor configured to trigger the locking mechanism to prevent rotation of the shaft when the shaft rotates at a rate above a predetermined threshold, and wherein the locking mechanism further comprises a vehicle inertia sensor configured to trigger the locking mechanism to prevent rotation of the shaft when the vehicle moves at a rate above a predetermined threshold.

11. The apparatus of claim 10 wherein the vehicle inertia sensor is positioned vertically above a lock wheel on the first sidewall.

12. The apparatus of claim 1 wherein the locking mechanism further comprises a load limiting feature configured to allow additional pay-out of the web after the locking mechanism has been triggered.

13. The apparatus of claim 1, further comprising a conical bearing in the cover and rotatably supported by an end portion of the shaft.

14. The apparatus of claim 1 wherein the frame and the cover include a plurality of indentations and protrusions that define a tortuous path around a perimeter of the locking mechanism.

15. The apparatus of claim 1 wherein the locking mechanism includes a web inertia sensor and a vehicle inertia sensor, wherein the vehicle inertia sensor is positioned at an upper portion of the first sidewall, and wherein the apparatus further comprises:
a spring assembly positioned proximate the second sidewall of the frame and operably coupled to the shaft, wherein the spring assembly is configured to apply a torque to the shaft to exert tension on the seat belt web during extension and drive web retraction;
a gasket between the cover and the first sidewall of the frame, the gasket being configured to form a seal between the first sidewall and the cover and between the first sidewall and a portion of the locking mechanism; and
a sealed bearing rotatably supporting the shaft on the first sidewall of the frame, wherein sealed bearing is configured to form a seal between the shaft and the frame.

16. The apparatus of claim 1, further comprising means sealing the locking mechanism within the enclosure.

17. A web retractor, comprising:
a frame having a first sidewall and a second sidewall opposite the first sidewall;
a shaft extending into openings in the first and second sidewalls and configured to carry a web;
a locking mechanism positioned proximate to the first sidewall and operably coupled to the shaft, the locking mechanism having a vehicle inertia sensor configured to activate the locking mechanism to prevent rotation of the shaft above a predetermined acceleration threshold, the locking mechanism further having a web inertia sensor configured to activate the locking mechanism to prevent rotation of the shaft above a predetermined rotational speed of the shaft;
a cover carried by the first sidewall and enclosing the locking mechanism, wherein the cover and the frame define an enclosure around the locking mechanism;
a first sealing feature between the cover and the first sidewall; and
a second sealing feature positioned between the shaft and the opening in the first sidewall, wherein the first and second sealing features are configured to prevent liquid from entering an enclosure.

18. The web retractor of claim 17 wherein the first sealing feature is a gasket positioned between the locking mechanism and the first sidewall.

19. The web retractor of claim 17 wherein the second sealing feature is a bearing having a sealing ring positioned between opposing bearing surfaces.

20. The web retractor of claim 17 wherein the cover includes a drain feature configured to allow liquid to exit the enclosure and prevent liquid from entering the enclosure.

21. The web retractor of claim 17 wherein the vehicle inertia sensor includes a vehicle sensor mass movably positioned vertically above a lock wheel.

22. A method of making a web retractor, the method comprising:
rotatably coupling a spool having a spring-loaded shaft between opposing sidewalls of a frame, wherein the shaft rotates in a first direction to wind a web about the spool and a second direction opposite the first direction to unwind the web from the spool;
attaching a spool locking mechanism to one of the sidewalls, wherein the locking mechanism includes at least one of a vehicle inertia sensor and a web inertia sensor;
operably coupling the locking mechanism to the shaft, and
enclosing the locking mechanism between a cover and the first sidewall, wherein the cover and the first sidewall form at least a substantially liquid-tight seal around the locking mechanism.

23. The method of claim 22, further comprising positioning a gasket between the cover and the first sidewall to seal the interface therebetween.

24. The method of claim 22, further comprising rotatably supporting the shaft with a sealed bearing carried by the first sidewall, the sealed bearing including a sealing ring adjacent a bearing surface.

25. The method of claim 22, further comprising forming a drain feature in a lower portion of the cover, wherein the drain feature is configured to allow liquid to exit the cover and prevent liquid from entering the cover.
